(19) United States
(12) Patent Application Publication
(10) Pub. No.: US 2010/0284761 A1
(43) Pub. Date: Nov. 11, 2010

(54) Press Type Fastener

(75) Inventor: Hiroyuki KATO, Utsunomiya-shi (JP)

Correspondence Address: THE BLACK & DECKER CORPORATION, 701 EAST JOPPA ROAD, TW199, TOWSON, MD, 21286, US

(73) Assignee: NEWFREY LLC, Newark, DE (US)

(21) Appl. No.: 12/614,914

(22) Filed: Nov. 9, 2009

(30) Foreign Application Priority Data
Nov. 7, 2008 (JP) 2008-287072

(51) Int. Cl. F16B 13/06

(52) U.S. Cl. 411/54.1

(57) ABSTRACT

A fastener comprises a pin, made of plastic, having a pin head and a pin shank, and a bushing, made of metal, having a bushing flange and a pair of bushing legs, which pin and bushing are coupled in a non-opened coupled condition with a gap between the pin head and the bushing flange, further comprising latching recesses formed at positions adjacent to the tip ends of the pin shank, together with first latching projections, formed in the bushing legs, for maintaining the non-opened coupled condition, and second latching projections, formed at the tip ends of the bushing legs, for maintaining a opened coupled condition, and the pin shank is formed to a length in the axial dimension wherewith, in the non-opened coupled condition, when the first latching projections are mated with the latching recesses, the tip end thereof does not protrude from the second latching projections of the bushing legs to the tip ends thereof.

### CROSS-REFERENCE TO RELATED APPLICATIONS

This application claims the benefit of Japanese Application No. 2008-284091 filed Nov. 7, 2008, the disclosure of which is incorporated herein by reference.

### TECHNICAL FIELD

The present invention relates to a press type fastener that comprises a metal bushing and a plastic pin, for clamping an attaching member by pressing the pin into the bushing.

### BACKGROUND TECHNOLOGY

Press type fasteners, comprising a metal bushing and plastic pin, for clamping an attaching member by pressing the pin into the bushing, such as that described in Patent Literature 1, for example, are known. The fastener described in Patent Literature 1 comprises a metal bushing and a plastic pin, which pin has a pin head and a pin shank extending downward from the pin head, which bushing has a bushing flange wherein is formed a hole through which the pin shank is passed, and a pair of bushing legs that extend downward from the bushing flange, which pin shank passes through the bushing flange and is accepted between the pair of bushing legs, which pin and bushing are coupled in a condition wherein there is a gap between the pin head and the bushing flange, so that when the pin shank is pressed into the bushing legs so as to eliminate that gap, the bushing legs open laterally, and an attaching member is clamped between the opened bushing legs and the bushing flange.

With the fastener described in Patent Literature 1, the attaching member is positioned so that the attachment hole lines up with the member being attached to, so that the attaching member can be coupled to the member being attached to merely by pressing the legs of the bushing to which the pin is coupled into the attachment holes of both members, pressing that pin into the bushing so as to eliminate the gap between the pin head and the bushing flange, wherefore an advantage is gained in that the operation is simple and easy.

Patent Literature 1: TOKKAI [Unexamined Patent Application] No. H8-270627 (Gazette)

Patent Literature 2: TOKKAI No. 2000-081012 (Gazette)

The fastener described in Patent Literature 1 affords the advantage of the fastening operation being simple and easy because an attaching member can be coupled to a member being attached to merely by pressing the pin into the bushing. In its condition prior to use, when the pin and bushing are coupled with a gap between the pin head and the bushing flange, the width of the pair of bushing legs is greater than the diameter of the attachment holes; wherefore, when inserting the bushing legs into the attachment holes, an operation for diminishing the width of the bushing legs is necessary. Moreover, in the condition prior to use wherein the pin and bushing are coupled, the tip end of the pin shank protrudes from the tip ends of the bushing legs; wherefore, when attachment is made to an attaching member by pressing the pin in, the pin shank extends out farther to the back surface side of the attaching member such that the fastener cannot be used in cases where there is no space on the back side of the attaching member.

In Patent Literature 2 a fastener comprising a pin and a bushing is described. With this fastener also, an attaching member can be coupled to a member being attached to merely by pressing the pin into the bushing. With this fastener, moreover, the bushing legs are formed so as to extend a considerable distance to the back side of the attachment hole and member being attached to, so the fastener cannot be used in cases where there is no space on the back side of the attaching member and member being attached to.

### SUMMARY OF THE INVENTION

The present invention provides a press type fastener that comprises a pin and a bushing, which is easy to insert into the attachment hole of an attaching member, and wherewith the length of protrusion to the back surface side of the attaching member and member being attached to is short.

According to one aspect of the present invention provides a press type fastener comprising a metal bushing and a plastic pin; the pin has a pin head and a pin shank that extends down from the pin head; the bushing has a bushing flange wherein a hole is formed, through which the pin shank passes, and a pair of bushing legs each of which extends downward from the bushing flange; the pin shank passes through the bushing flange and is accepted between the pair of bushing legs; latching means for coupling the pin and the bushing, in a condition such that a gap exists between the pin head and the bushing flange, are provided, respectively, in the pin shank and in the bushing legs; the bushing legs are configured so as to open laterally when the pin shank is pressed into the bushing legs so as to eliminate the gap between the pin head and the bushing flange; the fastener is for clamping an attaching member between the opened bushing legs and the bushing flange; wherein the latching means comprise latching recesses formed in the pin shank at positions where the bushing legs are thereby engaged, those being positions adjacent to the tip end of the pin shank, and first latching projections formed in the bushing legs so as to mate with the latching recesses at positions where they couple the pin and the bushing in the condition in which the gap is provided between the pin head and the bushing flange; the first latching projections are formed at positions separated from the tips of the bushing legs; second latching projections are formed in the tip ends of the bushing legs for mating with the latching recesses at positions where the pin shank is pressed into the bushing legs to a position at which the gap disappears, and thereby maintaining the bushing legs in the condition of being open laterally; whereupon, when the first latching projections have been mated with the latching recesses, the pin shank is coupled to the bushing legs in such condition that the bushing legs are not opened, in a non-opened coupled condition such that the pin and the bushing are coupled with the gap being opened; and the pin shank is formed to a length in the axial direction such that in the non-opened coupled condition, the tip end thereof does not protrude from the second fastening projections of the bushing legs toward the tip ends.

With the fastener described above, the advantage of a simple and easy operation of attaching to an attaching member (and a member being attached to) merely by pressing the pin into the bushing is retained, while in the non-opened coupled condition in which the first latching projections are mated with the latching recesses, the bushing legs do not open; thus, it is extremely easy to effect insertion into an attachment hole in the attaching member (and in the member being attached to). The pin shank, furthermore, is formed to a length in the axial direction wherewith the tip end thereof will not protrude toward the tip end(s) from the second latching projections of the bushing legs, so that the length of protrusion to the back surface side of the attaching member or member being attached to is made short, so that the fastener can be used even in cases where there is no space on the back side of the attaching member and member being attached to.

In the fastener described above, each of the pair of bushing legs is formed as an outwardly extending part that, at the first latching projections, curves inward so as mutually to diminish the interval, but, in the portion of the bush legs connecting to the second latching projections, curves outward so as mutually to enlarge the interval, being formed also so as again to curve inward, at the tip ends where the second latching projections are formed, so as mutually to diminish the interval. In this way, bushing legs and pin shanks of short length can be realized. The latching recesses in the pin shank are shaped so as to mate with the first latching projections so that the interval, on the outer surface, between the pair of bushing legs is maintained to or less than the diameter of an attachment hole in the attaching member in the non-opened coupled condition. Immediately before the opened coupled condition is reached, with the pin shank pressed into the bushing legs so as to eliminate the gap, and thereby opening those bushing legs laterally, the tip end portion of the pin shank that is adjacent to the latching recesses engages the second latching projections, and the pin shank tip end portion rides over the second latching projections when the pressing-in of the pin shank is finished, producing a clicking sensation. In this way, a worker can know with certainty when the pressing-in is finished. The bushing legs are bent at the root ends thereof so as to extend downward from the bushing flange; these bent portions are formed of portions that extend diagonally so as to approach the bushing flange and portions that curve in directions extending downward from the bushing flange, being formed such that the clearance between the inner walls of the attachment hole of the attaching member and the side surfaces of the bushing legs can be diminished. In this way, large clearance is no longer necessary, as in the case of curved shapes that are simple R (rounded) shapes, nor is it necessary to take shape variations, in the case of R shapes, into consideration. The bushing flange is formed in a shape having a rectangular outline, as seen in a plan view, and the pin head has side walls which, in the opened coupled condition, engage the side surfaces of the bushing flange.

### BRIEF DESCRIPTION OF THE DRAWINGS

FIG. 1 is a diagonal view of a press type fastener relating to an exemplary embodiment of the present invention.

FIG. 2 is a front elevation of the fastener diagrammed in FIG. 1.

FIG. 3 is a right side elevation of the fastener diagrammed in FIG. 2.

FIG. 4 is a section, at the A-A line, of the fastener diagrammed in FIG. 2.

FIG. 5 is a section, at the B-B line, of the fastener diagrammed in FIG. 3.

FIG. 6 is a front elevation of the pin of the fastener diagrammed in FIG. 1.

FIG. 7 is a bottom view of the pin diagrammed in FIG. 6

FIG. 8 is a right side elevation of the pin diagrammed in FIG. 6.

FIG. 9 is a section, at the C-C line, of the pin diagrammed in FIG. 8.

FIG. 10 is a plan of the bushing of the fastener diagrammed in FIG. 1.

FIG. 11 is a front elevation of the bushing diagrammed in FIG. 10.

FIG. 12 is a bottom view of the bushing diagrammed in FIG. 11.

FIG. 13 is a right side elevation of the bushing diagrammed in FIG. 11.

FIG. 14 is a section, at the D-D line, of the bushing diagrammed in FIG. 10.

FIG. 15 is a diagram of the fastener diagrammed in FIG. 2, prior to inserting the fastener into the attaching member and the member being attached to.

FIG. 16 is a diagram of the fastener diagrammed in FIG. 15, with the fastener inserted into the attaching member and the member being attached to, but prior to the completion of the attaching operation.

FIG. 17 is a diagram of the fastener diagrammed in FIG. 2, with the fastener attached to the attaching member and the member being attached to.

FIG. 18 is a right side elevation of the fastener diagrammed in FIG. 17.

FIG. 19 is a diagram of the action of preventing the pin, in the opened coupled condition, from pulling away from the bushing.

FIG. 20 is a diagram representing the non-opened coupled condition and the opened coupled condition of the bushing diagrammed in FIG. 11.

FIGS. 21(A) and 21(B) are diagrams comparing the actions of bent portions at the roots of bushing legs.

### DETAILED DESCRIPTION OF EXEMPLARY EMBODIMENTS OF THE INVENTION

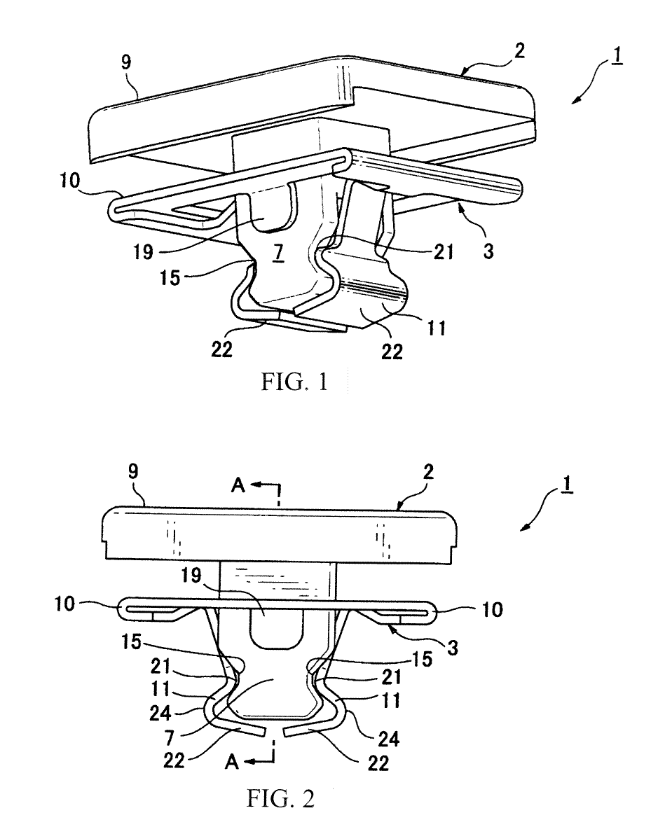

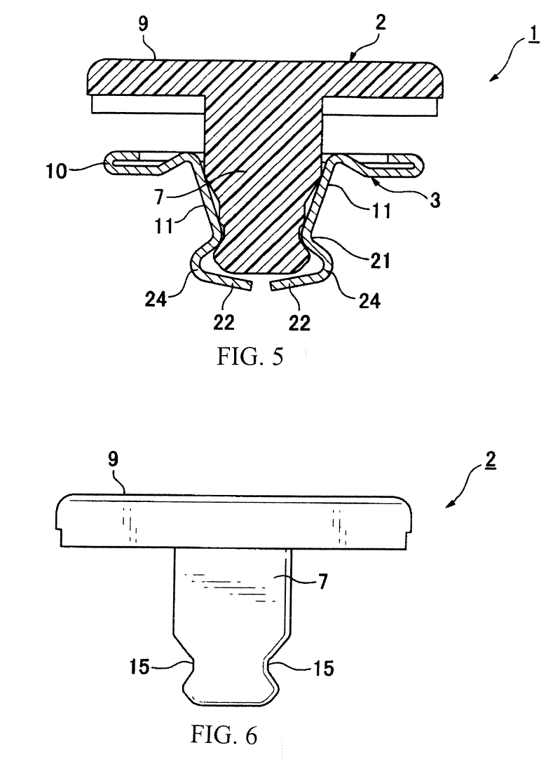

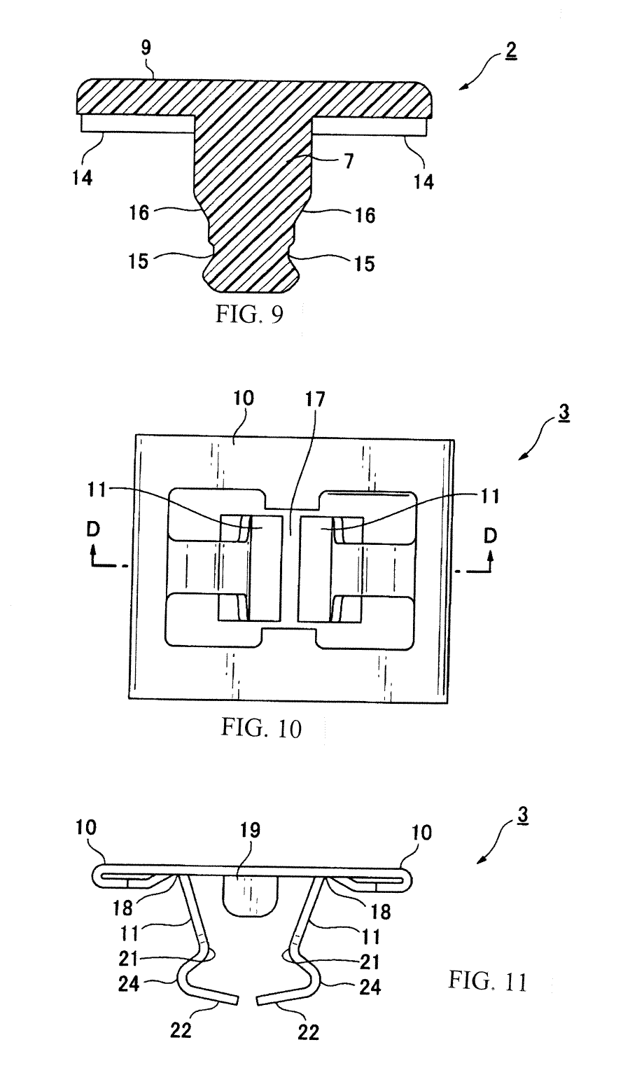

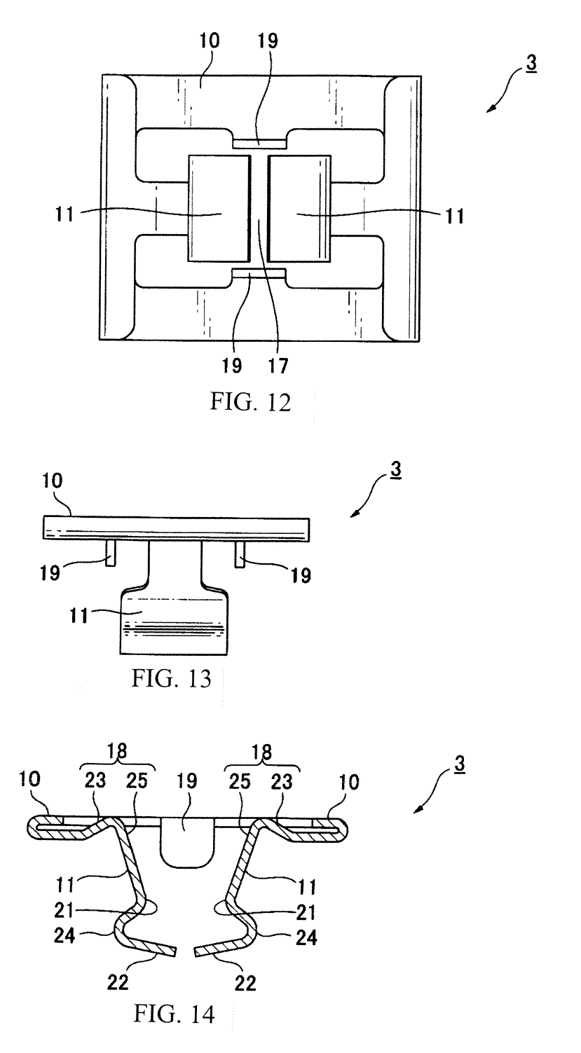

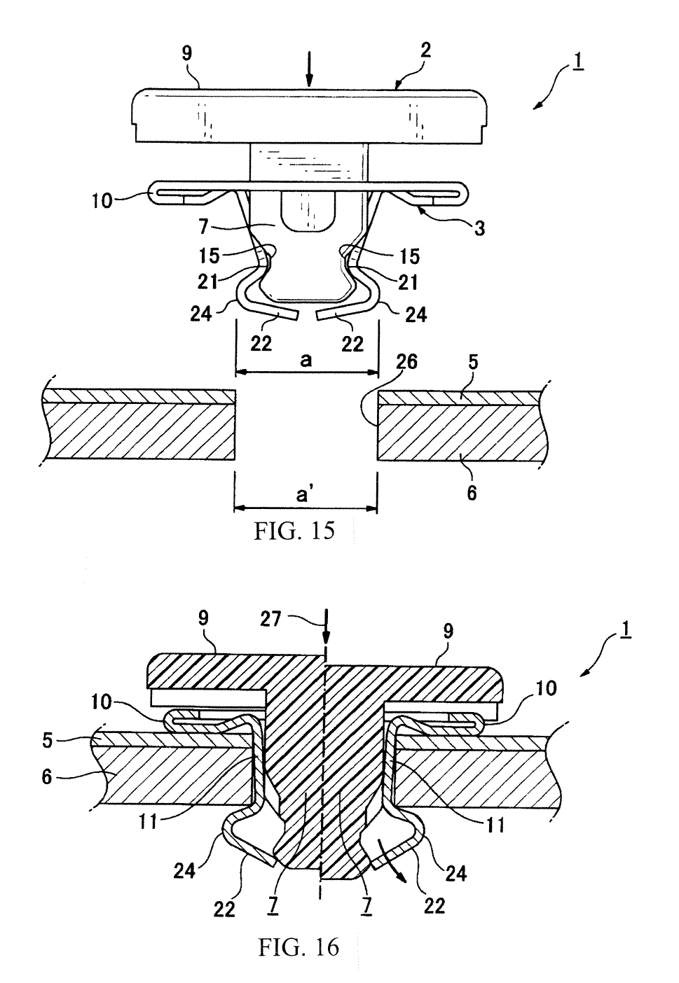

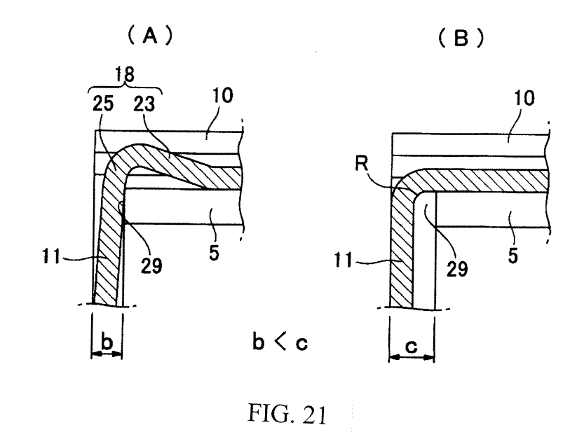

A press type fastener 1 relating to one embodiment of the present invention is now described with reference to the drawings. In FIGS. 1 to 5, the fastener 1 is diagrammed with a pin 2 and bushing 3 coupled in a prior-to-use condition. In FIGS. 6 to 9, the pin 2 is diagrammed by itself. In FIGS. 10 to 14, the bushing 3 is diagrammed by itself. In FIGS. 15 to 19, the action by which an attaching member 5 and a member being attached to 6 are coupled, using the fastener 1, is diagrammed. In FIGS. 20 and 21, the action of the bushing 3 when that bushing 3 is attached to the attaching member 5 and the member being attached to 6 is diagrammed.

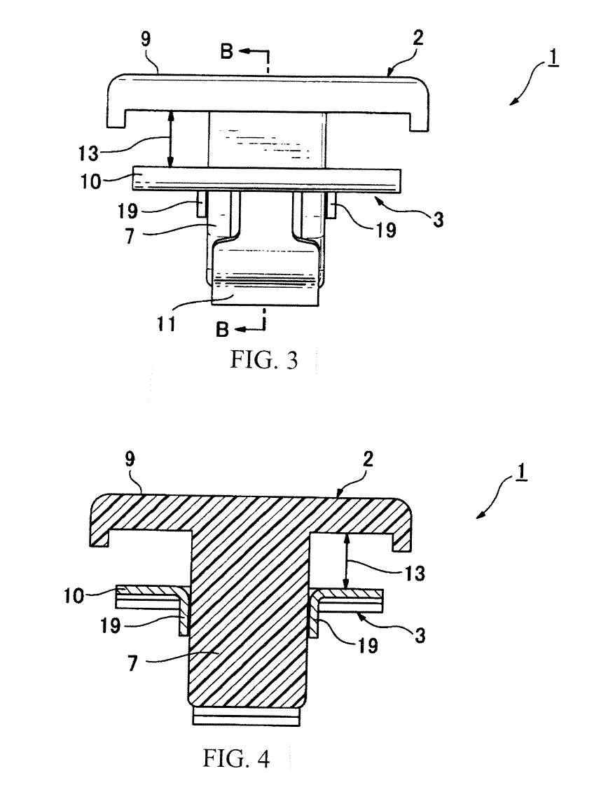

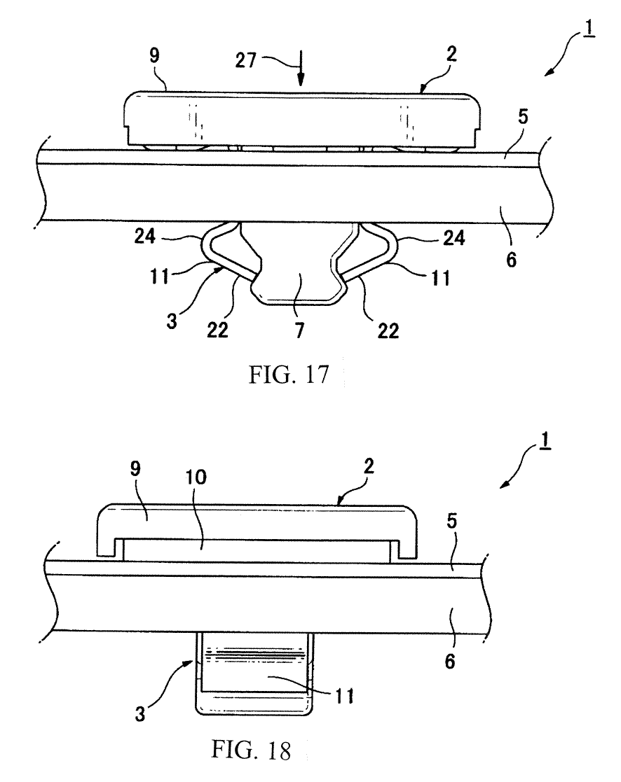

In FIGS. 1 to 5, the fastener 1 comprises a plastic pin 2 and a metal bushing 3, with the pin 2 and bushing 3 coupled in the prior-to-use condition. The pin 2 has a pin head 9 and a pin shank 7 which extends downward from the pin head 9. The bushing 3 has a bushing flange 10 wherein is formed a hole through which the pin shank 7 passes, and a pair of bushing legs 11 extending downward from the bushing flange 10. The pin shank 7 passes through the bushing flange 10 and is accepted between the pair of bushing legs 11, and, in the condition wherein the pair of bushing legs 11 are not opened, is coupled to the bushing legs 11, whereupon the pin 2 and bushing 3 are coupled in the prior-to-use condition. In this prior-to-use coupled condition, there is a gap 13 between the pin head 9 and the bushing flange 10, as diagrammed in FIG. 3, and it is therein possible to press the pin shank 7 into the bushing legs 11 so as to eliminate the gap 13. When the pin 2 and bushing 3 are in the prior-to-use coupled condition diagrammed, the pin shank 7 is not opening the bushing legs 11; thus, that prior-to-use coupled condition is called the non-opened coupled condition. The pin shank 7 is formed to a length in the axial direction, such that when in the non-opened coupled condition, the tip end thereof will not protrude out past the tip ends of the bushing legs 11. In order that the pin 2 and bushing 3 be maintained in the non-opened coupled condition, latching means are provided in the pin shank 7 and the bushing leg 11, respectively. When in this non-opened coupled condition, as diagrammed in FIG. 15, the pair of bushing legs 11 is not opened, and the pair of bushing legs 11 are formed so that the interval a between the outer surface of one bushing leg 11 and the outer surface of the other bushing leg 11 is maintained at or less than the attachment hole a′ of the member being attached to. In contradistinction to the non-opened coupled condition, moreover, the condition wherein the pin shank 7 is pressed into the bushing legs 11 so as to eliminate the gap 13, and the pin shank 7 has opened the bushing legs 11, is called the opened coupled condition. When in this opened coupled condition, the attaching member 5 and member being attached to 6 are mutually coupled (cf. FIG. 17).

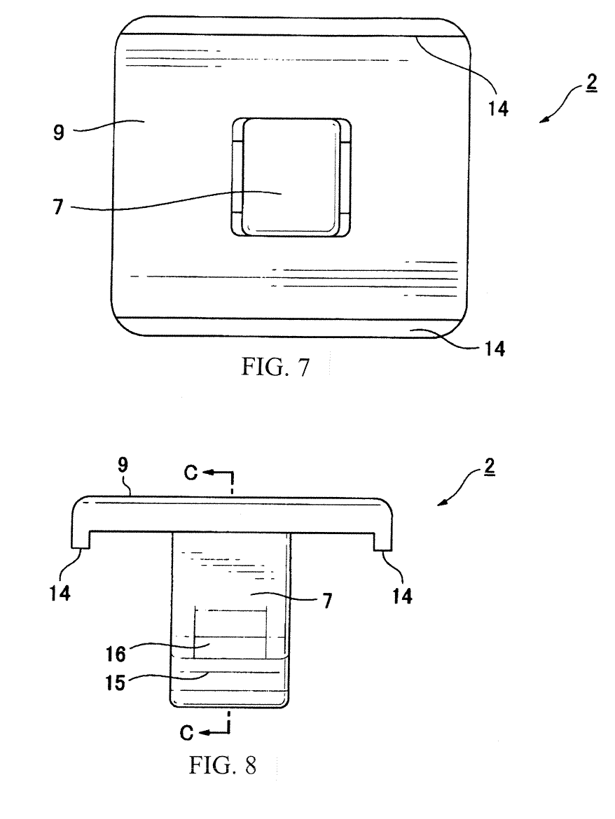

A detailed description of the pin 2 is now given with reference to FIGS. 6 to 9. The pin 2 is integrally molded of a plastic material. The pin 2 has a pin head 9, and a pin shank 7 which extends downward from the pin head 9. In the embodiment diagrammed, the pin head 9 is formed in a rectangular flange shape, as seen in the bottom view in FIG. 7, being formed so as to match the shape of the bushing flange 10 (a shape having a rectangular outline, as seen in a plan view like that in FIG. 10) and has a pair of side walls 14 that in the opened coupled condition wherein the pin 2 has been pressed into the bushing 3 and the bushing legs 11 are opened, engage the side surfaces of the bushing flange 10. In this way, in the opened coupled condition, the pin 2 is prevented from turning about its axis relative to the bushing 3, and the opening of the bushing legs is definitely maintained. In the pin shank 7 are provided latching means for coupling the pin 2 and the bushing 3. These latching means are latching recesses 15 that are formed at positions adjacent to the tip end of the pin shank 7 where they will engage with the inside of the bushing legs 11. The latching recesses 15 are formed in a pair so as to mate together with the latching means of the bushing legs formed on the insides of the pair of bushing legs 11. In the pin shank 7, slanting diagonal surfaces 16 are formed, adjacent to the latching recesses 15, so as to face the sides of the pin head 9. When the pin shank 7 is pressed in, from the non-opened coupled condition to the opened coupled condition, these slanting diagonal surfaces 16 aid the latching means of the bushing leg 11 to slide smoothly from the latching recesses 15. The pin shank 7 may have a round rod shape, but it is preferable that it have a square rod shape, as diagrammed; the latching recesses 15 can thus readily be positioned at the latching means of the bushing legs 11.

A detailed description of the bushing 3 is now given with reference to FIGS. 10 to 14. The bushing 3 is an integrally molded product made of a metal. The bushing 3 may be formed, for example, of a plate metal material such as steel which exhibits elasticity, by a stamping-out and bending process. As described above, the bushing 3 has a bushing flange 10 in which is formed a hole 17 through which the pin shank 7 passes and a pair of bushing legs 11 that extend downward from the bushing flange 10, between which pair of bushing legs 11 the pin shank 7 is inserted. Each of the bushing legs 11, as diagrammed in FIG. 11 and FIG. 14, after being folded back from the side edges of the bushing flange 10 and extending along the lower surface of the bushing flange 10, is bent at the root portions 18 and extends so as to drop downward from the bushing flange 10. In the bushing flange 10, a pair of guides 19 is formed for guiding the pin shank 7 between the bushing leg 11 into which the pin shank 7 is inserted.

In each of the bushing legs 11 are formed latching means for coupling the pin 2 and bushing 3 in both the non-opened coupled condition and the opened coupled condition. First, first latching projections 21 for mating with the latching recesses 15 of the pin shank 7 in its position in the non-opened coupled condition wherein the pin 2 and bushing 3 are coupled in such condition that a gap 13 is established between the pin head 9 and the bushing flange 10 are formed in the bushing legs 11 at positions on the sides of the bushing flange 10 separated from the tip ends of the bushing legs 11. Moreover, second latching projections 22 for mating with the latching recesses 15 of the pin shank 7 in its position where the pin 2 and bushing 3 are coupled in the opened coupled condition with the pin shank 7 pressed into the bushing legs 11 so that the gap 13 between the pin head 9 and the bushing flange 10 disappears are formed at the tip ends of the bushing legs 11. In order to form the first latching projections 21 and the second latching projections 22, the bushing legs 11 curve to the inside so as to diminish the interval therebetween at the first latching projections 21, then curve to the outside so as to increase the interval therebetween at the bushing leg portions leading to the second latching projections 22 to form outwardly bulging parts 24, again curve to the inside so as to diminish the interval therebetween at the tip ends thereof where the second latching projections 22 are formed. The outwardly bulging parts 24 act as bushing leg portions which clamp the attaching member in the opened coupled condition. The bushing legs 11, moreover, exhibit spring elasticity that restores them to their original attitude after being opened by the insertion of the pin shank 7.

The first latching projections 21, as diagrammed, are formed by inwardly bulging curved portions, with the sides of the bushing flange 10 formed as somewhat gently sloping diagonal surfaces, which diagonal surface portions slide over the slanting diagonal surfaces 16 of the latching recesses 15 of the pin shank 7 to facilitate pressing in the pin shank 7 in the opened coupled condition. The second latching projections 22 are tip end portions that face to the inside of the bushing legs 11 and mate with the latching recesses 15 so as to maintain the pressed-in pin shank 7 and bushing legs 11 in the opened coupled condition. The second latching projections 22 are formed in such shape as to produce, together with the latching recesses 15, a clicking sensation when the tip end portions of the pin shank 7 adjacent to the latching recesses 15 engage the second latching projections 22, immediately before the opened coupled condition is realized, and the tip end portions of the pin shank 7, due to the completion of the pressing-in of the pin shank 7, ride over the second latching projections 22. In this way, a worker can know for certain that the pressing-in has been completed. The second latching projections 22 engage the latching recesses 15 as the pressing-in is completed, thereby preventing the pin 2 from pulling away from the bushing 3 and keeping the outwardly bulging parts 24 of the bushing legs 11 open.

As diagrammed in FIG. 14, each of the bushing legs 11 is bent at the root portion 18, so as to extend downward from the bushing flange 10. These bent root portions 18 are formed of portions 23 that extend diagonally so as to approach the bushing flange 10 and portions 25 that curve in directions so as to extend downward from the bushing flange 10, being formed so that the clearance between the inner walls of the attachment holes in the attaching member (and in the member being attached to) and the side surfaces of the bushing legs 11 can be diminished. As a consequence, the need for a large clearance, as in the case of simply curved R shapes, is eliminated, while further-more, concern about shape variation in R-shape cases is also eliminated. Moreover, the bushing flange 10 is formed in a shape having a rectangular outline in the plan view (FIG. 10), so that in the opened coupled condition, the side surfaces of the bushing flange 10 engage the side walls 14 of the pin head 9, the pin 2 is prevented in turning about its axis relative to the bushing 3, and the opening of the bushing legs is definitely maintained. Furthermore, the shape of each bushing leg 11 is formed, as diagrammed in FIG. 13, so as to be wide in the portion on the tip end side from the outwardly bulging parts 24, so that the coupling strength on the attaching member 5 (and the member being attached to 6) clamped between the bushing flange 10 and the bushing legs 11 in the opened coupled condition is enhanced.

As can be seen, once again referring to FIGS. 1 to 5, the pin 2 is coupled in the non-opened coupled condition to the bushing 3. That is, the pin shank 7 passes through the bushing flange 10, is pressed in between the pair of bushing legs 11, the first latching projections 21 of the bushing legs 11 mate with the latching recesses 15 of the pin shank 7, and the pin 2 and bushing 3 are maintained so as to be coupled in the non-opened coupled condition. In this condition, as diagrammed in FIGS. 3 and 4, the gap 13 is opened between the pin head 9 and the bushing flange 10, whereupon the pin shank 7 can be pressed into the bushing legs 11 to effect the opened coupled condition. In the fastener 1 when in the non-opened coupled condition, the tip end of the pin shank 7 does not protrude out from the second latching projections 22 at the tip ends of the bushing legs 11, so the length of the fastener 1 in the axial direction can be kept short.

The operation of using the fastener 1, configured as described above, to couple the attaching member 5 to the member being attached to 6 shall now be described with reference to FIGS. 15 to 19. In FIG. 15, the fastener 1, in its condition prior to use with the pin 2 and bushing 3 coupled in the non-opened coupled condition, is positioned so as to face an attachment hole 26 in the attaching member 5 and the member being attached to 6. In the fastener 1 in the non-opened coupled condition, the gap a between the outer surface of the outwardly bulging part 24 in one bushing leg 11 and the outer surface of the outwardly bulging part 24 in the other bushing leg 11 is maintained so as to be equal to or less than the attachment hole a′ in the attaching member. Accordingly, the insertion of the bushing legs 11 can be easily accomplished. With the fastener 1, the bushing legs 11 are inserted into the attachment hole 26, and the bushing flange 10 is brought flush against the upper surface of the attaching member 5.

In FIG. 16, the pin head 9 is pressed in, as indicated by the arrow 27, and the pin shank 7 is pressed into the bushing legs 11. By this pressing-in, the pin shank 7 is pressed into the bushing legs 11, and the latching recesses 15 move downward so as to disengage from the first latching projections 21. When the pin shank 7 moves downward, then, as diagrammed in FIG. 16, the pin shank 7 pushes the pair of bushing legs 11 out to the sides, from the inside to the outside, and the outwardly bulging parts 24 open outward along the lower surface of the member being attached to 6. The second latching projections 22, as diagrammed in the left half of FIG. 16, immediately prior to the opened coupled condition being established, engage the tip end portion of the pin shank 7 adjacent to the latching recesses 15, and, as diagrammed in the right half of FIG. 16, try to ride over the tip end portion of the pin shank 7. Then, when the tip end portion of the pin shank 7 rides over the second latching projections 22 due to the pressing-in of the pin shank 7 being completed, a clicking sensation is produced and that clicking sensation is conveyed to the hand of the worker. As a consequence, the worker can know definitely that the pressing-in has been completed.

FIGS. 17 and 18 show how the attaching member 5 is coupled to the member being attached to 6, with the pressing-in of the pin shank 7 being complete and the bushing legs 11 of the fastener 1 in the opened coupled condition. With the pressing-in of the pin shank 7, the second latching projections 22 engage the latching recesses 15, and the opened coupled condition is maintained. In this opened coupled condition, the outwardly bulging parts 24 of the bushing legs 11 are put into a condition of bulging out to the sides, so that they work together with the bushing flange 10 to clamp the attaching member 5 and the member being attached to 6 together and couple the attaching member 5 to the member being attached to 6. In the opened coupled condition, with the second latching projections 22 mated with the latching recesses 15, the pin 2 is prevented from pulling out from the bushing 3. Moreover, as diagrammed in FIGS. 17 and 18, the length by which the tip end of the pin shank 7 protrudes from the tip ends of the bushing legs 11 is extremely short. This is because in the pin shank, the tip end thereof is formed to a length in the axial direction such that the tip end thereof will not protrude, from the second latching projections of the bushing legs, to the tip end, the second latching projections 22 are formed at the tip ends of the bushing legs 11, and the latching recesses 15 of the pin shank 7 are formed adjacent to the tip end of the pin shank 7. Because the length by which the tip end of the pin shank 7 protrudes from the tip ends of the bushing legs 11 is extremely short, the length of the protrusion to the back surface side of the attaching member 5 (or of the member being attached to 6) is also short, so that the fastener 1 can be used even when there is no space at the back sides of the attaching member and the member being attached to.

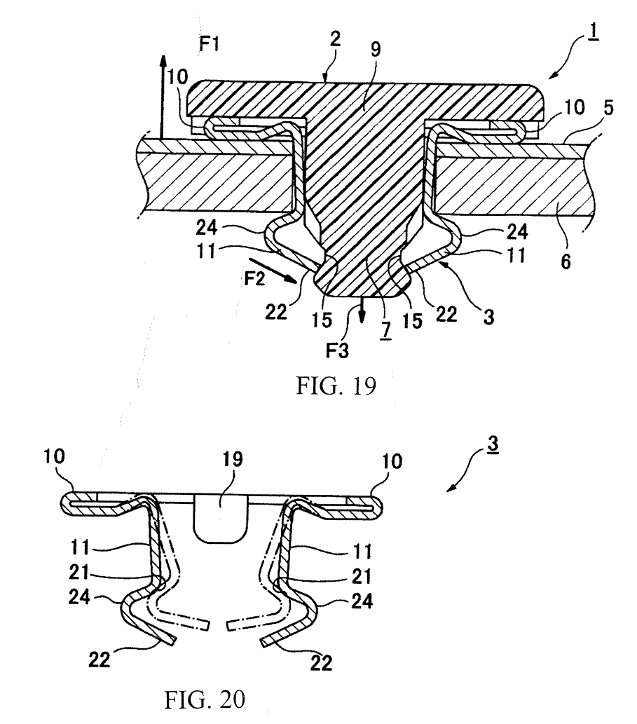

In FIG. 19, if we consider the case where a pulling-out load F1 is brought to bear, we see that the pulling-out load F1 applied to the bushing flange 10 and the bushing legs 11 acts on the outwardly bulging parts 24 and is applied to the latching recesses 15 of the pin shank 7 as a resisting force F2 against the pulling-out load, which force F2 is transmitted as a load F3 to the pin shank 7. The load F3 acts in the direction in which the pin shank 7 is pressed in, and becomes a force that resists pulling out so the pin 2 is prevented from being pulled out from the bushing 3. In the opened coupled condition, because the pin head 9 is superimposed on the bushing flange 10, the force F3 resisting the pulling-out load F1 is maintained even higher.

FIG. 20 represents the transformation between the non-opened coupled condition and the opened coupled condition of the bushing 3 when there is no pin 2. The condition indicated by the thin lines is the non-opened coupled condition of the bushing 3, while the condition indicated by the thick lines is the opened coupled condition of the bushing 3.

FIG. 21(A) diagrams how the bent root portion 18 at the root of each of the bushing legs 11 is formed of a portion 23 that extends diagonally so as to approach the bushing flange 10, and a portion 25 that curves in a direction that extends downward from the bushing flange 10. Due to this shape, the clearance 29 between the inner walls of the attachment hole 26 of the attaching member 5 (and member being attached to 6) and the side surfaces of the bushing legs 11 can be made small. FIG. 21(B) diagrams a case where the bending portion at the root of the bushing leg is in a simple R-shaped curved shape. In the FIG. 21(B) case, the clearance 29 has to be made large. Moreover, even should the variation in a case where such an R shape is formed be within the range of tolerance, the clearance must be made even larger. That being so, the shape of the root portion 18 diagrammed in FIG. 21(A) does not require a large clearance as does the case diagrammed in FIG. 21(B), and any need to consider variation in the R-shape case is eliminated.

It will be appreciated by persons skilled in the art that the above embodiments have been described by way of example only, and not in any limitative sense, and that various alterations and modifications are possible without departure from the scope of the invention as defined by the appended claims.

What is claimed is:

1. A press type fastener comprising:
a metal bushing and a plastic pin, said pin having a pin head, and a pin shank that extends down from the pin head and said bushing including a bushing flange wherein is formed a hole through which said pin shank passes, and said bushing further including a pair of bushing legs each of which extends downward from that bushing flange;
wherein said pin shank passes through said bushing flange and is accepted between said pair of bushing legs;
further comprising latching members for coupling said pin and said bushing, in a condition such that a gap exists between said pin head and said bushing flange, the latching members being provided in the pin shank and in the bushing legs;
wherein said bushing legs are configured so as to open laterally when said pin shank is pressed into said bushing legs so as to eliminate said gap between said pin head and said bushing flange;
wherein said latching members comprise latching recesses formed in the pin shank at positions where said bushing legs are thereby engaged, the positions being positions adjacent to a tip end of the pin shank, and first latching projections formed in the bushing legs so as to mate with said latching recesses at positions where they couple said pin and said bushing in the condition wherein said gap is provided between said pin head and said bushing flange;
wherein the first latching projections are formed at positions separated from the tips of said bushing legs;
wherein second latching projections are formed in the tip ends of said bushing legs, for mating with said latching recesses, at positions where said pin shank is pressed into said bushing legs to a position at which said gap disappears, and thereby maintaining said bushing legs in the condition of being open laterally;
wherein when said first latching projections have been mating with said latching recesses, said pin shank is coupled to said bushing legs in such condition that those bushing legs are not opened, in a non-opened coupled condition such that said pin and said bushing are coupled with said gap being opened; and
wherein said pin shank is formed to a length in the axial direction wherewith, in that non-opened coupled condition, the tip end thereof does not protrude from said second fastening projections of said bushing legs toward the tip ends thereof.

2. The fastener according to claim 1, wherein each of said pair of bushing legs is formed as an outwardly extending part that, at said first latching projections, curves inward so as mutually to diminish the interval therebetween, but, in the portion of the bush legs connecting to said second latching projections, curves outward so as mutually to enlarge the interval, being formed also so as again to curve inward, at the tip ends where said second latching projections are formed, so as mutually to diminish the interval.

3. The fastener according to claim 1, wherein said latching recesses in said pin shank are shaped so as to mate with said first latching projections so that the interval, on the outer surface, between said pair of bushing legs is maintained to or less than the diameter of an attachment hole in the attaching member, in said non-opened coupled condition.

4. The fastener according to claim 3, wherein, immediately before the opened coupled condition is reached, with said pin shank pressed into said bushing legs so as to eliminate said gap and thereby opening those bushing legs laterally, the tip end portion of said pin shank that is adjacent to said latching recesses engages said second latching projections, and said pin shank tip end portion rides over said second latching projections, when the pressing-in of said pin shank is finished.

5. The fastener according to claim 4, wherein said bushing legs are bent at the root ends thereof so as to extend downward from said bushing flange; these bent portions are formed of portions that extend diagonally so as to approach said bushing flange and portions that curve in directions extending downward from said bushing flange, being formed such that the clearance between the inner walls of the attachment hole of the attaching member and the side surfaces of said bushing legs can be diminished.

6. The fastener according to claim 5, wherein said bushing flange is formed in a shape having a rectangular outline, as seen in a plan view; and said pin head has side walls which, in the opened coupled condition wherein said pin shank is pressed into said bushing legs so as to eliminate said gap, and said bushing legs are opened laterally, engage the side surfaces of said bushing flange.

7. A fastener comprising:
a pin and a bushing;
wherein the pin comprises a pin head and a pin shank extending from the pin head, the pin shank including recesses;
the bushing a bushing flange and a pair of bushing legs extending from the bushing flange, the bushing legs comprising a pair of first latching projections;
wherein the bushing flange further comprises a hole through which the pin shank is inserted; and
wherein the bushing is connected to the pin by the engagement of the first latching projections with the recesses on the pin shank.

8. The fastener according to claim 7, wherein the fastener is movable between a fastening and a pre-fastening state;
wherein the bushing is connected to the pin by the engagement of the first latching projections with the recesses on the pin shank during the pre-fastening state; and
wherein during the pre-fastening state the pin flange is separated from the bushing flange by a first distance and during the fastening state the pin flange is separated from the bushing flange by a second distance which is shorter than the first distance.

9. The fastener according to claim 8, wherein the bushing legs move away from one another as the fastener moves from the pre-fastening state to the fastening state.

10. The fastener according to claim 9, wherein the bushing legs slope towards the axial center of the pin shank when in the pre-fastening state.

11. The fastener according to claim 10, wherein during the fastening state a part is held between the first latching projections and the bushing flange.

12. The fastener according to claim 11, wherein the bushing legs further include second latching projections which extend beyond a tip end of the pin shank in the pre-fastened state and which engage a tip end of the pin shank during the fastening state.

13. A fastener assembly comprising:
a pin a bushing and a pair of panel members;
wherein the pin comprises a pin head and a pin shank extending from the pin head, the pin shank including recesses;
the bushing a bushing flange and a pair of bushing legs extending from the bushing flange, the bushing legs comprising a pair of first latching projections and a pair of second latching projections;
wherein the bushing flange further comprises a hole through which the pin shank is inserted so that the bushing surrounds the pin shank; and
wherein the pair of panel members are held between the first latching member and the bushing flange and the second latching members engage a tip end of the pin shank.
